(19) United States
(12) Patent Application Publication
(10) Pub. No.: US 2020/0293860 A1
(43) Pub. Date: Sep. 17, 2020

(54) CLASSIFYING INFORMATION USING SPIKING NEURAL NETWORK

(71) Applicant: Infineon Technologies AG, Neubiberg (DE)

(72) Inventor: Cyprian GRASSMANN, Deisenhofen (DE)

(21) Appl. No.: 16/725,598

(22) Filed: Dec. 23, 2019

Related U.S. Application Data
(60) Provisional application No. 62/816,540, filed on Mar. 11, 2019.

(51) Int. Cl. G06N 3/04; G06N 3/08; G06N 3/063; G01S 7/41

(52) U.S. Cl. CPC G06N 3/049; G01S 7/417; G06N 3/0635; G06N 3/08

(57) ABSTRACT

A semiconductor device is provided. The semiconductor device may comprise a circuit configured to generate information. The semiconductor device may comprise a monitoring circuit coupled to the circuit. The monitoring circuit may be configured to receive a monitoring signal based upon the information from the circuit. The monitoring circuit may comprise a spiking neural network (SNN) configured to determine, based upon the monitoring signal, a first monitoring classification of a plurality of monitoring classifications associated with the circuit.

### RELATED APPLICATION

This application claims priority to U.S. Provisional Patent Application No. 62/816,540, filed on Mar. 11, 2019, entitled “CLASSIFYING INFORMATION USING SPIKING NEURAL NETWORK”, which is incorporated by reference herein in its entirety.

### TECHNICAL FIELD

The present disclosure relates to the field of classifying information and particularly to the use of neural networks for classifying information.

### BACKGROUND

In many systems, a first circuit may perform one or more operations. The first circuit may generate one or more signals. A second circuit may monitor the one or more signals.

### SUMMARY

This Summary is provided to introduce a selection of concepts in a simplified form that are further described below in the Detailed Description. This Summary is not intended to identify key factors or essential features of embodiments, nor is it intended to be used to limit the scope of embodiments.

In an embodiment, a sensor is provided. The sensor may comprise a radar circuit. The radar circuit may comprise a path configured to process a radar signal and/or output a first signal based upon the radar signal. The sensor may comprise neuromorphic circuitry. The neuromorphic circuitry may be configured to receive a second signal based upon the first signal. Alternatively and/or additionally, the neuromorphic circuitry may be configured to apply a spiking neural network (SNN) to the second signal to encode input information of the second signal as a sequence of spikes. Alternatively and/or additionally, the neuromorphic circuitry may be configured to classify the input information based upon the sequence of spikes.

In an embodiment, a method is provided. A radar signal may be processed via a path of a radar circuit. A first signal based upon the radar signal may be output via the path. A second signal based upon the first signal may be received via neuromorphic circuitry. A SNN may be applied to the second signal via the neuromorphic circuitry to encode input information of the second signal as a sequence of spikes. The input information may be classified via the neuromorphic circuitry based upon the sequence of spikes.

In an embodiment, a semiconductor device is provided. The semiconductor device may comprise a circuit configured to generate information. The semiconductor device may comprise a monitoring circuit coupled to the circuit. The monitoring circuit may be configured to receive a monitoring signal based upon the information from the circuit. The monitoring circuit may comprise a SNN configured to determine, based upon the monitoring signal, a first monitoring classification of a plurality of monitoring classifications associated with the circuit.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary system in which a spiking neural network (SNN) is applied to an input signal to output an output signal.

FIG. 2 is a component block diagram illustrating an exemplary system comprising a semiconductor device.

FIG. 3 is a component block diagram illustrating an exemplary system comprising a radar circuit and/or neuromorphic circuitry.

FIG. 4 is a component block diagram illustrating an exemplary system where signals are applied to neuromorphic circuitry.

FIG. 5 is a component block diagram illustrating an exemplary system where one or more signals are applied to an analog to spike sequence converter component.

FIG. 6 is an illustration of an example method in accordance with the techniques presented herein.

FIG. 7 is an example of a computer readable medium in which at least a portion of the currently presented techniques may be utilized.

FIG. 8 is an illustration of an example computing environment wherein at least a portion of the currently presented techniques may be utilized.

### DETAILED DESCRIPTION

Embodiments are now described with reference to the drawings, wherein like reference numerals are used to refer to like elements throughout. In the following description, for purposes of explanation, numerous specific details are set forth in order to provide a thorough understanding of embodiments. It may be evident, however, that embodiments may be practiced without these specific details. In other instances, well-known structures and devices are shown in block diagram form in order to facilitate describing embodiments.

A. Introduction

A first circuit (e.g., one or more of a radar circuit, a circuit configured to generate information, a circuit configured to perform signal processing, a circuit configured to perform one or more (other) functions, etc.) may be used in a system to perform one or more operations. The first circuit may process high frequency signals and/or may generate one or more signals associated with one or more specific frequency ranges (e.g., the one or more specific frequency ranges may correspond to one or more of High frequency (HF), Very high frequency (VHF), Ultra high frequency (UHF), Super high frequency (SHF), Extremely high frequency (EHF), etc.). In an example, the first circuit may be a radar circuit associated with a radar system. The radar system may be configured to determine one or more distances between the radar circuit and one or more objects. The radar circuit may transmit a first radar signal via a transmit path of the radar circuit and/or may receive a second radar signal via a receive path of the radar circuit. For example, the second radar signal may correspond to one or more reflections (of the first radar signal) from the one or more objects. In some examples, the radar circuit may process the second radar signal to determine one or more properties associated with the one or more objects based upon the first radar signal and/or the second radar signal. The second radar signal may be provided to a mixer to down-convert the second radar signal into a baseband signal. The baseband signal may be processed to extract information related to characteristics of objects reflecting the radar signal. In radar circuits as well as in other circuits, the one or more properties may comprise information indicative of one or more of a velocity of an object of the one or more objects, a distance of the object, a direction (of motion) of the object, etc.

A second circuit may be provided to process signals provided by and/or tapped off the first circuit. For example, the second circuit may be configured to determine information comprised within signals processed by the first circuit. The second circuit may for example comprise a radar processing circuit to further process received radar signals in order to determine characteristics of objects reflecting radar signals. In some examples, the second circuit may monitor one or more second signals output by the first circuit. For example, the second circuit may be a digital circuit and/or may comprise one or more of a microcontroller, a clock, a central processing unit (CPU), a digital signal processor (DSP) etc. used to perform one or more operations for monitoring the one or more second signals. The first circuit and the second circuit may be integrated on a same chip.

Conventional implementations of the second circuit may cause disturbances (e.g., noise, spurs, etc.) to one or more signals generated by the first circuit. In an example where processing by the second circuit is implemented as conventional digital processing, the clock of the second circuit may introduce harmonics affecting the operation of the first circuit and/or the one or more signals generated by the first circuit. Further, the harmonics may interfere with the one or more signals of the first circuit and/or with operation of the first circuit. For example, the harmonics may interfere with the first signal, the second signal and/or with operation of the radar circuit, causing the one or more properties associated with the one or more objects to be incorrectly determined, which may cause detection of ghost targets (e.g., detected objects that are not actually present) and/or ghost reflections (e.g., detected reflections that are not actually present).

In accordance with one or more of the techniques presented herein, a spiking neural network (SNN) may be implemented in a system (e.g., a radar system and/or a different type of system associated with signal processing, signal generation, signal transmission, and/or signal reception). The SNN may be configured to receive one or more signals from a circuit (of the system), classify information associated with the one or more signals and/or output second information associated with the one or more signals. The second information may be indicative of one or more classifications associated with the one or more signals, one or more behaviors associated with operation of the circuit, one or more instructions, and/or one or more other types of information. Further, the SNN may operate using analog circuitry such that minimal noise is introduced into the circuit and/or into signals associated with the system. For example, rather than using a synchronously clocked digital circuit to perform one or more operations associated with monitoring the one or more signals, by implementing the SNN in the system to perform operations (e.g., classify information associated with the one or more signals and/or output information associated with the one or more signals), a lower amount of disturbances (e.g., noise, spurs, etc.) may be introduced to the circuit.

B. Presented Techniques

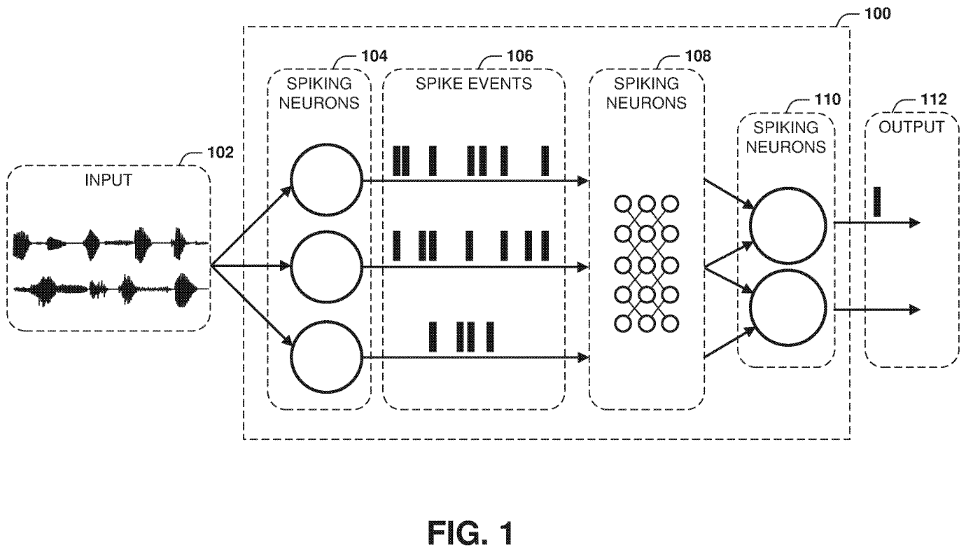

FIG. 1 is an illustration of an exemplary system in which a SNN 100 is applied to an input signal 102 to output an output signal 112. In some examples, the input signal 102 may be an analog signal received from a circuit (e.g., one or more of a radar circuit, a circuit configured to generate information, a circuit configured to perform signal processing, a circuit configured to perform one or more (other) functions, etc.). For example, the input signal 102 may be received via a connection between the SNN 100 and/or a circuit node (e.g., one or more circuit nodes) of the circuit. Alternatively and/or additionally, the input signal 102 may be derived from one or more signals of the circuit. Alternatively and/or additionally, the input signal 102 may be a digital signal.

A first set of spiking neurons 104 of the SNN 100 may be applied to the input signal 102 to encode input information of the input signal 102 as one or more sequences of spikes 106 (e.g., one or more spike trains). The input information may be encoded as the one or more sequences of spikes 106 based upon one or more characteristics associated with the input information. The one or more characteristics may correspond to one or more of voltage levels of the input signal 102, current levels of the input signal 102, a voltage amplitude of the input signal 102, a current amplitude of the input signal 102, etc. The one or more characteristics may correspond to one or more timing characteristics associated with one or more of voltage changes (e.g., voltage fluctuation) of the input signal 102 over time, current changes (e.g., current fluctuation) of the input signal 102 over time, one or more frequencies of the input signal 102, frequency changes of the input signal 102 over time, a phase of the input signal 102, temporal sequences (e.g., patterns) associated with the input signal 102, etc.

In some examples, the first set of spiking neurons 104 may be associated with a configuration of neurons. Alternatively and/or additionally, the configuration of neurons may comprise a plurality of resistors for setting weights of connections between neurons. A neuron of the first set of spiking neurons 104 may comprise one or more resistors. Connections between neurons of the first set of spiking neurons 104 and/or connections between resistors of the plurality of resistors may configure (and/or impact) operation of the first set of spiking neurons 104. Alternatively and/or additionally, resistance values of resistors of the plurality of resistors may configure (and/or impact) operation of the first set of spiking neurons 104. Alternatively and/or additionally, one or more resistors of the plurality of resistors may change over time (e.g., the input signal 102 and/or activity in the SNN 100 may cause one or more resistance values of the one or more resistors to change over time), which may resemble synaptic plasticity associated with brain function.

In some examples, a spike of the one or more sequences of spikes 106 may correspond to a voltage spike. For example, a spike may correspond to an increase in voltage, from a first voltage level to a second voltage level, followed by a decrease in voltage from the second voltage level to (approximately) the first voltage level. Alternatively and/or additionally, a spike of the one or more sequences of spikes 106 may correspond to a current spike. For example, a spike may correspond to an increase in current, from a first current level to a second current level, followed by a decrease in current from the second current level to (approximately) the first current level. The one or more sequences of spikes 106 may be associated with low energy and/or ultra-low energy (e.g., a voltage level and/or a current level of a spike may be low). It may be appreciated that by applying the first set of spiking neurons 104 to generate low energy and/or ultra-low energy spikes may result in benefits including, but not limited to, minimal power consumption by the SNN 100.

In some examples, the one or more sequences of spikes 106 may be applied to neurons of a second set of spiking neurons 108 and/or a third set of spiking neurons 110. The second set of spiking neurons 108 may correspond to a hidden layer of neurons associated with complex processing. In some examples, the second set of spiking neurons 108 may output one or more second sequences of spikes based upon the one or more sequences of spikes 106. Alternatively and/or additionally, the third set of spiking neurons 110 may output the output signal 112 based upon the one or more second sequences of spikes.

In some examples, the one or more sequences of spikes 106 may be indicative of second information associated with the input information of the input signal 102. The second information may be of a different type than the input information. For example, the input information may be related to an amplitude information and/or the second information may be related to a phase information of a frequency spectrum. Alternatively and/or additionally, the second information may be of the same type as the input information (and/or may be indicative of at least a portion of the input information). In some examples, one or more timing characteristics associated with spikes of the one or more sequences of spikes 106 may be indicative of the second information. The one or more timing characteristics associated with the one or more sequences of spikes 106 may correspond to one or more of a number of spikes per unit of time (e.g., a spike rate and/or a frequency associated with the number of spikes), timing relationships (e.g., one or more of spacings, time-lengths, distances, etc.) between spikes of the one or more sequences of spikes 106, temporal sequences (e.g., patterns) associated with spikes of the one or more sequences of spikes 106, etc.

In some examples, neurons of the second set of spiking neurons 108 and/or the third set of spiking neurons 110 may be sensitive to and/or may detect timing characteristics associated with the one or more sequences of spikes 106 and/or may (natively) perform sensor fusion and/or pattern recognition based upon timing relationships between spikes of the one or more sequences of spikes 106.

For example, temporal sequences, timing relationships between spikes and/or spike frequencies associated with the one or more sequences of spikes 106 may cause neuron activity of the second set of spiking neurons 108 and/or the third set of spiking neurons 110. The neuron activity may comprise one or more neurons of the second set of spiking neurons 108 and/or the third set of spiking neurons 110 outputting a spike (e.g., firing) responsive to one or more potentials associated with the one or more neurons exceeding a threshold potential value. For example, responsive to at least a portion of the one or more sequences of spikes 106 having one or more timing characteristics, one or more potentials of one or more neurons (of the second set of spiking neurons 108 and/or the third set of spiking neurons 110) may reach the threshold potential value and/or the one or more neurons may output one or more spikes (e.g., the one or more neurons may fire).

In some examples, the input information may be classified based upon the one or more sequences of spikes 106. For example, the one or more sequences of spikes 106 (and/or the second information associated with the one or more sequences of spikes 106) may be indicative of one or more behaviors associated with circuit operation of the circuit and/or indicative of signal properties of the one or more signals associated with the circuit. The second set of spiking neurons 108 and/or the third set of spiking neurons 110 (and/or circuitry separate from the SNN 100) may (natively) output the output signal 112 being indicative of one or more classifications, of a plurality of classifications, based upon the one or more sequences of spikes 106.

In some examples, a first classification of the plurality of classifications may correspond to a correct execution of operations (associated with the circuit and/or the input signal 102). In some examples, the correct execution of operations may correspond to a correct timing of operations performed by the circuit and/or to a correct order of operations performed by the circuit. Alternatively and/or additionally, the correct timing of operations may correspond to one or more operations that the circuit is configured (and/or instructed) to perform being performed by the circuit within a configured period of time (e.g., the circuit may be configured and/or instructed to perform operation X and operation Y within 5 microseconds; and the circuit may perform the operation X and the operation Y within 5 microseconds). Alternatively and/or additionally, the correct order of operations may correspond to one or more operations being performed by the circuit, wherein an order of performance of each operation of the one or more operations matches an order of operations that the circuit is configured (and/or instructed) to implement (e.g., the circuit may be configured and/or instructed to perform operation X, then operation Y, then operation Z; and the circuit may perform operation X, then operation Y, then operation Z).

Alternatively and/or additionally, a second classification of the plurality of classifications may correspond to an incorrect execution of operations (associated with the circuit and/or the input signal 102). In some examples, the incorrect execution of operations may correspond to an incorrect operation being performed by the circuit, an incorrect timing of operations performed by the circuit and/or to an incorrect order of operations performed by the circuit.

Alternatively and/or additionally, a third classification of the plurality of classifications may correspond to a phase deviation of the input signal 102 and/or the one or more signals being outside of a range. Alternatively and/or additionally, the third classification may correspond to channels of the input signal 102 and/or the one or more signals drifting differently over time resulting in a phase deviation that is outside of the range. Alternatively and/or additionally, the third classification may correspond to a difference between phase deviations of the input signal 102 and/or the one or more signals changing over time by greater than a threshold change. Alternatively and/or additionally, the third classification may correspond to a phase deviation of the input signal 102 and/or the one or more signals being higher than a first threshold phase deviation and/or lower than a second threshold phase deviation.

Alternatively and/or additionally, a fourth classification of the plurality of classifications may correspond to a frequency of the input signal 102 and/or the one or more signals of the circuit being outside of a range. Alternatively and/or additionally, the fourth classification may correspond to the frequency being higher than a first threshold frequency and/or lower than a second threshold frequency.

Alternatively and/or additionally, a fifth classification of the plurality of classifications may correspond to disturbances to the circuit exceeding a threshold level of disturbances. In some examples, the disturbances to the circuit may correspond to noise introduced to the circuit (e.g., noise, spurs, etc. interfering with the input signal 102, the one or more signals and/or one or more other signals associated with the circuit) higher than a threshold noise.

Alternatively and/or additionally, a sixth classification of the plurality of classifications may correspond to a behavior of the circuit. In some examples, the behavior of the circuit may correspond to one or more of one or more actions being performed by the circuit, a state of the circuit, a change of state of the circuit, one or more voltage levels associated with the circuit, one or more current levels associated with the circuit, one or more operating frequencies associated with the circuit, etc.

An occurrence of a sequence of spikes within the one or more sequences of spikes 106 having one or more exemplary timing characteristics may correspond to an exemplary classification of the plurality of classifications. The one or more exemplary timing characteristics may correspond to one or more exemplary temporal sequences of spikes, one or more exemplary timing relationships between spikes and/or an exemplary range of spikes per unit of time (e.g., a range of spike frequencies and/or spike rates). Accordingly, the sequence of spikes of the one or more sequences of spikes 106 may have the one or more exemplary timing characteristics and/or may be associated with the exemplary classification if the sequence of spikes has a temporal sequence of spikes of the one or more exemplary temporal sequences of spikes associated with the one or more exemplary timing characteristics. Alternatively and/or additionally, the sequence of spikes of the one or more sequences of spikes 106 may have the one or more exemplary timing characteristics and/or may be associated with the exemplary classification if the sequence of spikes has one or more timing relationships between spikes of the one or more exemplary timing relationships associated with the one or more exemplary timing characteristics. Alternatively and/or additionally, the sequence of spikes of the one or more sequences of spikes 106 may have the one or more exemplary timing characteristics and/or may be associated with the exemplary classification if the sequence of spikes has a number of spikes per unit of time within the exemplary range of spikes per unit of time associated with the one or more exemplary timing characteristics.

In some examples, a behavior and/or a state of the circuit (e.g., the correct execution of operations, the incorrect execution of operations, etc.) associated with the exemplary classification may cause the input signal 102 and/or the one or more signals to have one or more signal characteristics (e.g., amplitude, frequency, phase, etc.). The input signal 102 and/or the one or more signals having the one or more signal characteristics may cause the one or more sequences of spikes 106 to comprise a sequence of spikes having the one or more exemplary timing characteristics associated with the exemplary classification. The second set of spiking neurons 108 and/or the third set of spiking neurons 110 may output the output signal 112 being indicative of the exemplary classification based upon the occurrence of the sequence of spikes having the one or more exemplary timing characteristics within the one or more sequences of spikes 106.

In some examples, the SNN 100 may undergo training. In some examples, the training may be performed based upon activity of the circuit. For example, it may be determined that when the circuit operates in association with a first behavior and/or a first state, the input signal 102 may have a first set of (one or more) signal characteristics. For example, the first behavior and/or the first state may correspond to one or more of the correct execution of operations, the incorrect execution of operations, etc.

In some examples, the first set of signal characteristics may be determined by monitoring and/or analyzing the input signal 102 during times that the circuit operates in association with the first behavior and/or the first state. The first set of signal characteristics may correspond to a voltage level of the input signal 102. For example, during times that the circuit operates in association with the first behavior and/or the first state, the voltage level of the input signal 102 may be within a range of voltage levels associated with the first set of signal characteristics. Alternatively and/or additionally, the first set of signal characteristics may correspond to a current level of the input signal 102. For example, during times that the circuit operates in association with the first behavior and/or the first state, the current level of the input signal 102 may be within a range of current levels associated with the first set of signal characteristics. Alternatively and/or additionally, the first set of signal characteristics may correspond to a voltage amplitude and/or a current amplitude of the input signal 102. For example, during times that the circuit operates in association with the first behavior and/or the first state, the voltage amplitude may be within a range of voltage amplitudes associated with the first set of signal characteristics and/or the current amplitude of the input signal 102 may be within a range of current amplitudes associated with the first set of signal characteristics.

Alternatively and/or additionally, the first set of signal characteristics may correspond to a phase of the input signal 102. For example, during times that the circuit operates in association with the first behavior and/or the first state, the phase of the input signal 102 may be within a range of phases associated with the first set of signal characteristics. Alternatively and/or additionally, the first set of signal characteristics may correspond to a frequency of the input signal 102. For example, during times that the circuit operates in association with the first behavior and/or the first state, the frequency of the input signal 102 may be within a range of frequencies associated with the first set of signal characteristics.

In some examples, the SNN 100 may be trained such that when the SNN 100 is applied to the input signal 102 having the first set of signal characteristics, the input signal 102 is encoded as the one or more sequences of spikes 106 having one or more timing characteristics associated with the first behavior and/or the first state (e.g., the one or more sequences of spikes 106 may be indicative of the first behavior and/or the first state). For example, a first configuration of neurons of the SNN 100 may be applied to a signal having the first set of signal characteristics to encode information of the signal as a sequence of spikes. The first configuration of neurons of the SNN 100 may be updated based upon the sequence of spikes to generate a second configuration of neurons of the SNN 100. The second configuration of neurons of the SNN 100 may be applied to a second signal having the first set of signal characteristics to encode information of the second signal as a second sequence of spikes. Alternatively and/or additionally, the second configuration of neurons of the SNN 100 may be updated based upon the second sequence of spikes to generate a third configuration of neurons of the SNN 100. In some examples, training the SNN 100 may comprise generating multiple configurations of neurons of the SNN 100 until a configuration is generated that, when the configuration is applied to a signal having the first set of signal characteristics, information of the signal is encoded as a sequence of spikes having the one or more timing characteristics associated with the first behavior and/or the first state.

Alternatively and/or additionally, the SNN 100 may be trained such that when the one or more sequences of spikes 106 comprises an occurrence of a sequence of spikes having the one or more timing characteristics (associated with the first behavior and/or the first state), the output signal 112 is output being indicative of the first behavior and/or the first state.

In some examples, training the SNN 100, generating a configuration of neurons and/or updating the configuration of neurons may comprise one or more of adding one or more resistors to the SNN 100, modifying one or more resistance values of one or more resistors of the SNN 100, adding one or more connections between one or more resistors of the SNN 100, removing one or more connections between one or more resistors of the SNN 100, assigning one or more weights to one or more connections between one or more resistors of the SNN 100, adding one or more neurons to the SNN 100, modifying one or more neurons of the SNN 100, modifying characteristics and/or parameters of one or more neurons (e.g., threshold levels of one or more neurons), adding one or more connections between one or more neurons of the SNN 100, removing one or more connections between one or more neurons of the SNN 100, assigning one or more weights to one or more connections between one or more neurons of the SNN 100, etc.

Operation of the SNN 100 may be associated with a level of activity that may result in minimal amounts of disturbances and/or noise (and/or no disturbances and/or noise) being introduced to components of the exemplary system (e.g., the circuit). For example, a rate at which spikes are output (and/or fired) by neurons in the SNN 100 may be minimal and/or may introduce less disturbances and/or noise to the components of the exemplary system in comparison with systems comprising one or more of DSPs, CPUs, clocks, etc. used for classifying information. Further, in comparison with systems comprising one or more of DSPs, CPUs, microcontrollers, clocks, etc. used for classifying information, the SNN 100 may require less energy (e.g., a rate at which spikes are output (and/or fired) by neurons in the SNN 100 may be minimal and/or firing of spikes during operation of the SNN 100 may require a minimal amount of energy).

Alternatively and/or additionally, operation of the SNN 100 may be associated with asynchronous behavior. For example, some systems (e.g., digital systems) associated with synchronous behavior may be sequenced by periodic timing signals (e.g., clocks) which may result in harmonics and/or disturbances (and/or noise) being introduced to (surrounding) components and/or circuits. However, the SNN 100 may not be sequenced by a periodic timing signal (e.g., a clock), which may result in less energy consumption of the SNN 100 and/or less disturbances and/or noise being introduced to components of the exemplary system by the operation of the SNN 100.

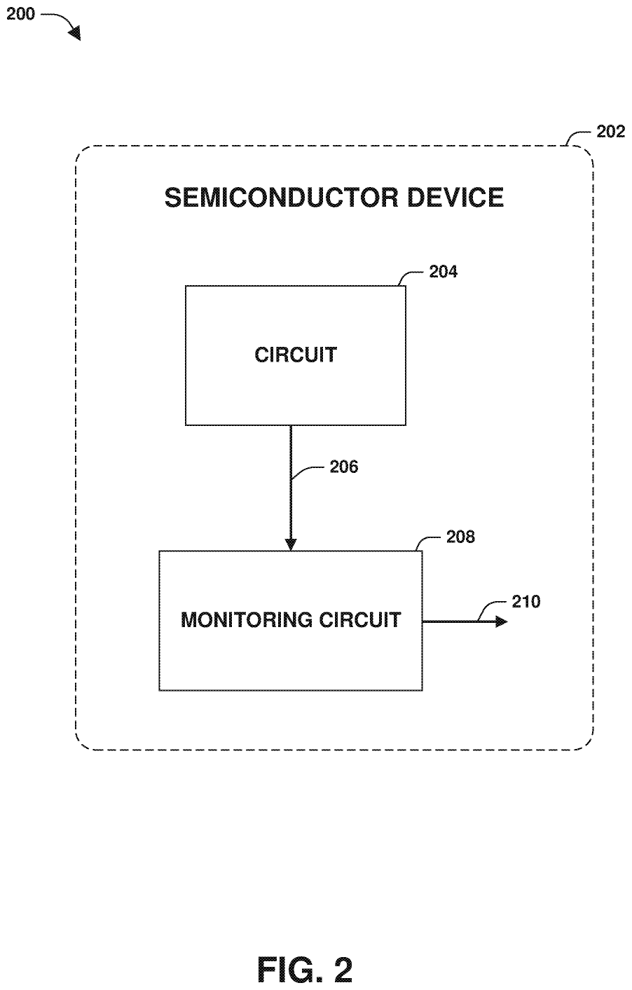

FIG. 2 is an illustration of an exemplary system 200 comprising a semiconductor device 202. For example, the semiconductor device 202 may comprise a circuit 204 and/or a monitoring circuit 208. In some examples, the circuit 204 may comprise one or more of a circuit configured to generate information, a radar circuit, a circuit configured to perform signal processing, a circuit configured to perform one or more (other) functions, etc.

The monitoring circuit 208 may be coupled to the circuit 204. The monitoring circuit 208 may be configured to receive a monitoring signal 206 from the circuit 204. For example, the monitoring signal 206 may be a tapped signal tapped at one or more circuit nodes of the circuit 204. The monitoring circuit 208 may comprise a SNN (e.g., the SNN 100, illustrated in FIG. 1). The SNN may be configured to determine a first monitoring classification of a plurality of monitoring classifications associated with the circuit 204 based upon the monitoring signal 206. For example, the monitoring signal 206 may be applied to one or more neurons of the SNN. In some examples, the SNN may be an analog SNN (comprising pure analog operating circuitry). Alternatively and/or additionally, the SNN may comprise digital circuitry.

In some examples, the plurality of monitoring classifications may comprise one or more classifications of the plurality of classifications described with respect to FIG. 1 and/or one or more classifications other than the plurality of classifications described with respect to FIG. 1.

The first monitoring classification associated with the circuit may be determined by applying the SNN to the monitoring signal 206. For example, the monitoring signal 206 may be associated with one or more signal characteristics of signals in the circuit 204. By applying the SNN to the monitoring signal 206 associated with the one or more signal characteristics, a SNN signal indicative of the first monitoring classification may be output by the SNN.

In some examples, the monitoring circuit 208 may operate concurrently with operation of the circuit 204. Operation of the circuit 204 may correspond to one or more of generating information, performing signal processing, etc. For example, the SNN may determine monitoring information (e.g., the first monitoring classification) and/or output the SNN signal indicative of the monitoring information concurrently with operation of the circuit 204. The SNN of the monitoring circuit 208 and/or the circuit 204 may operate concurrently as a result of the monitoring circuit 208 introducing minimal disturbances and/or noise (and/or no disturbances and/or noise) to the circuit 204. Operation of the monitoring circuit 208 may not (negatively) impact operation of the circuit 204.

Alternatively and/or additionally, a control signal may be applied to the circuit 204 to perform one or more operations. The SNN may be configured to receive a second signal indicative of an operation performed by the circuit 204. In some embodiments the operation may be based upon the control signal. For example, the monitoring information may be determined based upon the monitoring signal 206 and/or the second signal. For example, the monitoring signal 206 and the second signal may be applied to the SNN. The SNN may output the SNN signal indicative of the monitoring information based upon the monitoring signal 206 and/or the second signal. The SNN may receive only the monitoring signal 206 which may be a signal transmitted in a signal path of the circuit 204 or only the second signal indicative of an operation performed by the circuit 204. In other embodiments, the SNN may receive both signals, the monitoring signal 206 and the second signal.

In some examples, the monitoring circuit 208 may output an output signal 210. The output signal 210 may be the SNN signal (of the SNN). Alternatively and/or additionally, the output signal 210 may be generated based upon the SNN signal. For example, the monitoring circuit 208 (and/or the semiconductor device 202) may comprise a transmitter configured to generate the output signal 210 based upon the SNN signal and/or to transmit the output signal 210 to the circuit 204 and/or to a second circuit (e.g., a control circuit within the semiconductor device 202). The output signal 210 may be an analog signal and/or a digital signal. The output signal 210 may be indicative of the monitoring information.

In some examples, the output signal 210 may be received by the circuit 204 and/or the second circuit. In some examples, the circuit 204 may be monitored via the monitoring circuit 208. For example, the circuit 204 may be monitored using the monitoring circuit 208 and/or the output signal 210. For example, the circuit 204 may be monitored (continuously and/or non-continuously) for correct functioning using the output signal 210 to determine whether configured signal processing operations are being performed, whether signals are being generated having timing characteristics (e.g., frequency, phase, etc.) that are in accordance with configurations of the circuit 204, whether noise and/or disturbances exceeding a threshold are introduced to the circuit 204 and/or signals of the circuit 204, whether operations performed by components of the circuit 204 are performed in accordance with a correct order of operations associated with the circuit 204, whether operations performed by components of the circuit 204 are performed in accordance with a correct timing of operations associated with the circuit 204, etc. For example, the output signal 210 may be monitored by control circuitry of the semiconductor device 202. Responsive to identifying a classification of the plurality of monitoring classifications indicated by the output signal 210, the control circuitry may perform one or more first operations associated with the classification and/or may trigger the circuit 204 (and/or one or more other circuits) to perform one or more second operations associated with the classification. For example, the one or more operations and/or the one or more second operations may correspond to one or more of outputting one or more warning signals, one or more reset operations, one or more recalibrate operations, one or more shutdown operations, adjusting and/or modifying signals being generated and/or processed, adjusting and/or modifying signal processing techniques implemented by the circuit 204, adjusting and/or modifying settings and/or parameters used for generating information and/or processing signals by the circuit 204, etc.

In a first example where the output signal 210 is indicative of the first monitoring classification and/or the first monitoring classification is associated with the first classification described with respect to FIG. 1 (e.g., the correct execution of operations), the circuit 204 and/or one or more other circuits (within the semiconductor device 202) may resume operation (e.g., the circuit 204 may (continue to) generate the information and/or (continue to) perform the signal processing). One or more signals indicative of the correct execution of operations of the circuit 204 may be transmitted to one or more other components, for example an external electronic control component.

In a second example, the output signal 210 is indicative of the first monitoring classification and/or the first monitoring classification is associated with one or more of the second classification, the third classification, the fourth classification and/or the fifth classification described with respect to FIG. 1.

In a third example, the first monitoring classification may be associated with a phase difference between different items of the monitoring signal 206 and/or a phase difference between the monitoring signal 206 and a different signal received via the semiconductor device 202 being higher than a threshold phase difference and/or lower than a second threshold phase difference. In the third example, the circuit 204 and/or one or more other circuits (within the semiconductor device 202) may be triggered to perform one or more operations based upon the first monitoring classification (e.g., the one or more operations may comprise one or more of outputting one or more warning signals, one or more reset operations, one or more recalibrate operations, one or more shutdown operations, etc.).

In a fourth example, the first monitoring classification may be associated with a frequency difference between different items of the monitoring signal 206 and/or a frequency difference between the monitoring signal 206 and a different signal received via the semiconductor device 202 being higher than a threshold frequency difference and/or lower than a second threshold frequency difference. In a fifth example, the first monitoring classification may be associated with unsafe operation of the circuit 204 and/or one or more other circuits within the semiconductor device 202. For example, the unsafe operation may correspond to one or more of the circuit 204 and/or the one or more other circuits operating at a voltage higher than a threshold voltage, the circuit 204 and/or the one or more other circuits operating at a current higher than a threshold current, the circuit 204 and/or the one or more other circuits consuming an amount of power greater than a threshold amount of power, the circuit 204 and/or the one or more other circuits being overheated, etc.

In the third example, the fourth example and/or the fifth example, the circuit 204 and/or the one or more other circuits (within the semiconductor device 202) may be triggered to perform one or more operations based upon the first monitoring classification (e.g., the one or more operations may comprise one or more of outputting one or more warning signals, one or more reset operations, one or more recalibrate operations, one or more shutdown operations, etc.).

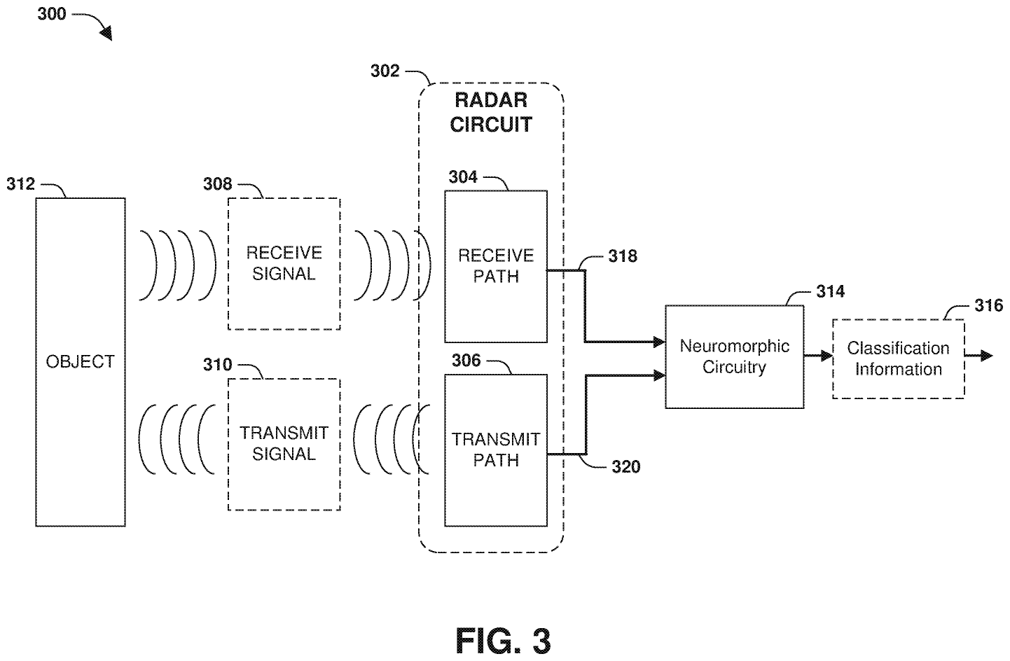

FIG. 3 is an illustration of an exemplary system 300 comprising a radar circuit 302 and neuromorphic circuitry 314. For example, the radar circuit 302 and the neuromorphic circuitry 314 may be comprised within a sensor (e.g., a radar sensor). In some examples, the radar circuit 302 and the neuromorphic circuitry 314 may be implemented on a single semiconductor chip and/or in a single semiconductor package. The radar circuit 302 may comprise a transmit path 306 configured to transmit a radar transmit signal 310. Alternatively and/or additionally, the radar circuit 302 may comprise a receive path 304 configured to receive a radar receive signal 308. For example, the radar receive signal 308 may correspond to a reflection of the radar transmit signal 310 from an object 312.

The radar circuit 302 may be configured to determine one or more properties associated with the object based upon the radar transmit signal 310 and/or the radar receive signal 308. The one or more properties may comprise one or more of a distance between the radar circuit 302 and the object 312, a velocity of the object 312 relative to the radar circuit 302, an acceleration of the object 312, a direction (of motion) of the object 312, etc.

For example, the radar circuit 302 may implement one or more techniques in order to determine the one or more properties. For example, frequency-modulated continuous-wave (FMCW) radar ranging may be implemented in which the radar transmit signal 310 is a periodic radar signal transmitted continuously or non-continuously by the transmit path 306, where a frequency of the radar transmit signal 310 is increased (e.g., steadily and/or uniformly increased) over an increasing frequency ramp portion and/or decreased over a decreasing frequency ramp portion. The radar receive signal 308 may be processed by the receive path 304 (e.g., down-converted). The receive path may output and/or generate a first signal (e.g., a base band signal) based upon the radar receive signal 308 using one or more components of the receive path 304. Information comprised within the first signal may be determined and/or extracted by further processing as will be described below.

The neuromorphic circuitry 314 may be configured to receive a second signal 318 based upon the first signal. The radar receive signal 308 may have a frequency within a first range of frequencies (e.g., a gigahertz range of frequencies), and/or the first signal may be down-converted to the second signal 318 having a frequency within a second range of frequencies (e.g., a megahertz range of frequencies).

The neuromorphic circuitry 314 may be configured to apply a SNN (e.g., the SNN 100 illustrated in FIG. 1) to the second signal 318 to encode first input information of the second signal 318 as a sequence of spikes. Alternatively and/or additionally, the neuromorphic circuitry 314 may be configured to classify the first input information based upon the sequence of spikes. The receive path 304 may be configured to process and/or receive radar signals (e.g., the radar receive signal 308) concurrently with the neuromorphic circuitry 314 applying the SNN to the second signal 318.

In some examples, the neuromorphic circuitry 314 may comprise pure analog operating circuitry configured to encode the input information as the sequence of spikes and/or to classify the input information based upon the sequence of spikes. For example, the neuromorphic circuitry 314 may not comprise digital circuitry and/or may not generate digital signals. Alternatively and/or additionally, at least a portion of the neuromorphic circuitry 314 may comprise digital circuitry and/or one or more digital signals may be generated by the neuromorphic circuitry 314. The SNN may be an analog SNN.

In some examples, the transmit path 306 may be configured to output a third signal based upon the radar transmit signal 310. Alternatively and/or additionally, the neuromorphic circuitry 314 may be configured to receive a fourth signal 320 based upon the third signal. For example, the third signal may be down-converted to generate the fourth signal 320.

The neuromorphic circuitry 314 may be configured to apply the SNN to the second signal 318 and/or the fourth signal 320 to encode first input information of the second signal 318 and/or second input information of the fourth signal 320 as the sequence of spikes. Alternatively and/or additionally, the neuromorphic circuitry 314 may be configured to classify information comprised within the second signal 318 and/or information comprised within the fourth signal 320 based upon the sequence of spikes. The transmit path 306 may be configured to process and/or transmit radar signals (e.g., the radar transmit signal 310) concurrently with the neuromorphic circuitry 314 applying the SNN to the second signal 318 and/or the fourth signal 320.

Alternatively and/or additionally, the neuromorphic circuitry 314 may be configured to apply a first part of the SNN (e.g., a first configuration of neurons of the SNN) to the second signal 318 to encode the first input information of the second signal 318 as the sequence of spikes. The neuromorphic circuitry 314 may be configured to apply a second part of the SNN (e.g., a second configuration of neurons of the SNN) to the fourth signal 320 to encode the second input information of the fourth signal 320 as a second sequence of spikes (separate from the sequence of spikes). Alternatively and/or additionally, the neuromorphic circuitry 314 may be configured to classify the first input information and/or the second input information based upon the sequence of spikes and/or the second sequence of spikes.

In some examples, the neuromorphic circuitry 314 may be configured to classify the first input information and/or the second input information as being associated with one or more classifications of a plurality of classifications. In some examples, the plurality of classifications may comprise the first classification, the second classification, the third classification, the fourth classification, the fifth classification and/or the sixth classification described with respect to FIG. 1.

In some examples, a seventh classification of the plurality of classifications may correspond to noise. For example, the seventh classification may be indicative of the radar transmit signal 310, the radar receive signal 308, the second signal 318 and/or the fourth signal 320 comprising noise (e.g., which may be associated with detection of a ghost target and/or detection of a ghost reflection) and/or a level of noise exceeding a threshold level of noise. In some examples, the seventh classification may be determined based upon the sequence of spikes and/or the second sequence of spikes. For example, the SNN may be applied to the sequence of spikes and/or the second sequence of spikes to output a SNN signal comprising classification information indicative of the seventh classification.

In some examples, the neuromorphic circuitry 314 may output an output signal 316. The output signal 316 may be the SNN signal. Alternatively and/or additionally, the output signal 316 may be generated based upon the SNN signal. The output signal 316 may be indicative of the classification information. For example, the sensor may comprise a transmitter configured to generate the output signal 316 based upon the SNN signal. The transmitter may be configured to transmit the output signal 316 to the radar circuit 302 and/or to control circuitry of the sensor.

In some examples, the radar circuit 302 and/or the control circuitry may perform one or more operations based upon the output signal 316. In an example where the output signal 316 is indicative of the seventh classification, the radar circuit 302 and/or the control circuitry may be triggered to perform one or more operations associated with reducing the noise.

In some examples, an eighth classification of the plurality of classifications may correspond to a reflection from the object 312. The eighth classification may be indicative of the radar receive signal 308 being a reflection of the radar transmit signal 310 reflected by the object 312 (and/or the radar receive signal 308 not being a reflection reflected by the object 312).

A ninth classification of the plurality of classifications may correspond to information (e.g., spectral peak information) comprised within a base band signal. For example, the information may be information comprised within the base band signal of each chirp of a series of radar chirps indicating a relative distance to the object 312. Alternatively and/or additionally, the information may be indicative of a variation of at least one characteristic comprised within the baseband signal over the series of radar chirps indicating a relative velocity of the object 312. Alternatively and/or additionally, the information may be indicative of a variation of at least one characteristic contained in baseband signals corresponding to multiple receive antennas indicating a direction of arrival.

A tenth classification of the plurality of classifications may correspond to a correct operation of the receive path 304 and/or the transmit path 306. The tenth classification may be associated with a property of the radar receive signal 308 and/or the radar transmit signal 310 being within a range associated with (correct operation of) the receive path 304. The property may correspond to one or more of a voltage level, a current level, a voltage amplitude, a current amplitude, a power consumption, a timing relationship between the radar receive signal 308 and the radar transmit signal 310, a phase, a frequency, etc.

An eleventh classification of the plurality of classifications may correspond to an incorrect operation of the receive path 304 and/or the transmit path 306. The eleventh classification may be associated with the property being outside of the range.

In some examples, the control circuitry may be configured to apply (and/or transmit) one or more control signals to the receive path 304 and/or the transmit path 306 to trigger operations. A twelfth classification of the plurality of classifications may correspond to a correct execution of the triggered operations. Alternatively and/or additionally, a thirteenth classification of the plurality of classifications may correspond to an incorrect execution of the triggered operations.

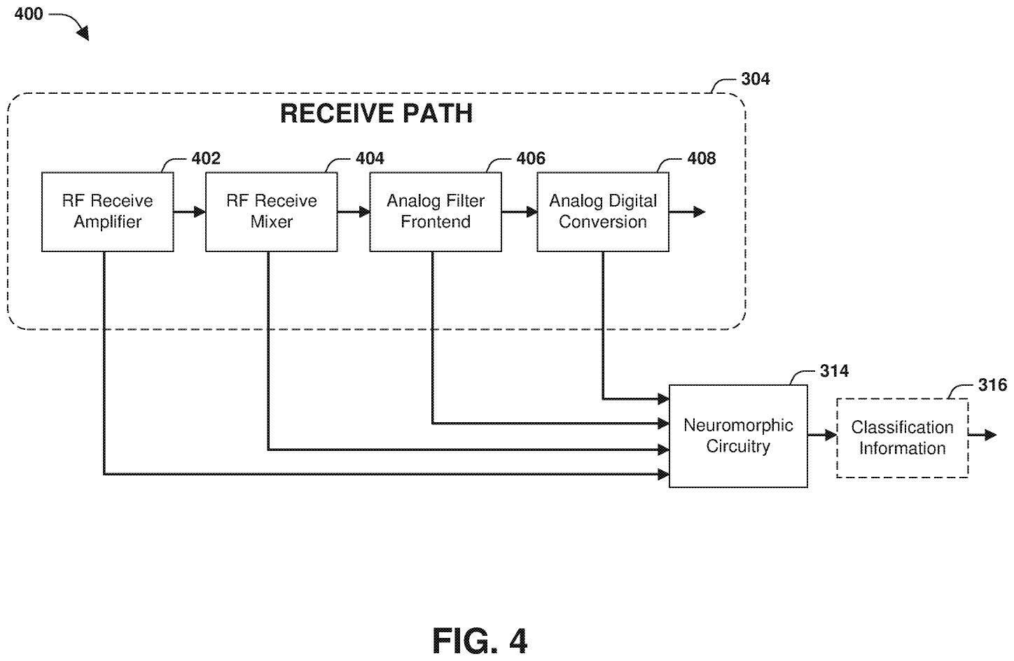

FIG. 4 illustrates an exemplary system 400 where a plurality of component signals associated with a plurality of components of the receive path 304 are applied (and/or transmitted) to the neuromorphic circuitry 314. For example, the plurality of components may comprise a radio frequency (RF) receive amplifier component 402, a RF receive mixer component 404, an analog filter frontend component 406 and/or an analog digital conversion component 408. In some examples, the neuromorphic circuitry 314 may be configured to apply the SNN to one or more first signals of the plurality of component signals (e.g., the plurality of component signals may be generated by the plurality of components). Alternatively and/or additionally, a second plurality of component signals generated by a second plurality of components of the transmit path 306 may be applied to the neuromorphic circuitry 314. In some examples, the neuromorphic circuitry 314 may be configured to apply the SNN to one or more second signals of the second plurality of signals. For example, the neuromorphic circuitry 314 may encode information of the one or more first signals and/or the one or more second signals as one or more sequences of spikes. The information may be classified based upon the one or more sequences of spikes.

In some examples, the twelfth classification may correspond to a correct timing of the triggered operations performed by the receive path 304 and/or the transmit path 306. Alternatively and/or additionally, the twelfth classification may correspond to a correct order of the triggered operations performed by the receive path 304 and/or the transmit path 306.

The thirteenth classification may correspond to an incorrect timing of the triggered operations performed by the receive path 304 and/or the transmit path 306. Alternatively and/or additionally, the thirteenth classification may correspond to an incorrect order of the triggered operations performed by the receive path 304 and/or the transmit path 306.

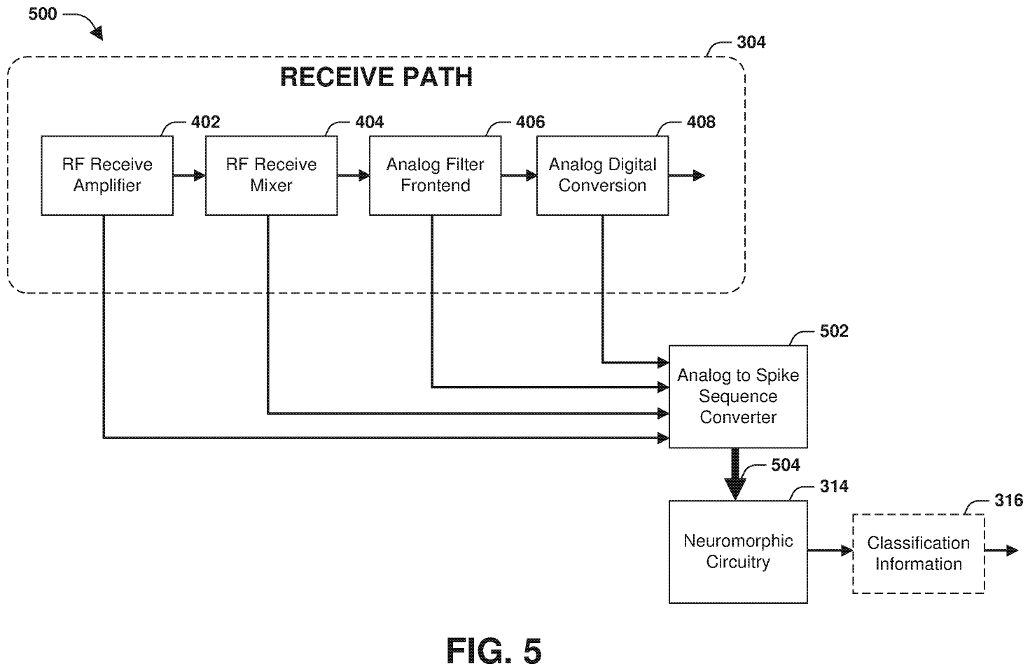

FIG. 5 illustrates an exemplary system 500 of an example embodiment where the one or more first signals and/or the one or more second signals are applied to an analog to spike sequence converter component 502. In some examples, the analog to spike sequence converter component 502 may generate one or more spike sequence signals 504 indicative of one or more second sequences of spikes. Information of the one or more first signals (associated with the receive path 304) and/or the one or more second signals (associated with the transmit path 306) may be classified based upon the one or more second sequences of spikes.

In some examples, the radar circuit 302 may be monitored via the neuromorphic circuitry 314. For example, operation of the radar circuit 302 may be monitored using the neuromorphic circuitry 314 and/or the output signal 316. For example, the operation of the radar circuit 302 may be monitored (continuously and/or non-continuously) using the neuromorphic circuitry 314 and/or the output signal 316 to determine whether signal processing operations are being performed in accordance with configurations of the radar circuit 302 and/or the sensor, whether signals are being generated having timing characteristics (e.g., frequency, phase, etc.) that are in accordance with configurations of the radar circuit 302 and/or the sensor, whether noise and/or disturbances exceeding a threshold are introduced to the radar circuit 302 and/or signals of the radar circuit 302, whether operations performed by components of the radar circuit 302 are performed in accordance with a correct order of operations associated with the radar circuit 302, whether operations performed by components of the radar circuit 302 are performed in accordance with a correct timing of operations associated with the radar circuit 302, etc. The output signal 316 may be monitored by the control circuitry to monitor the operation of the radar circuit 302.

Responsive to identifying a classification of the plurality of classifications indicated and/or applied by the output signal 316, the control circuitry may perform one or more first operations associated with the classification and/or may trigger the radar circuit 302 to perform one or more second operations associated with the classification. For example, the one or more first operations and/or the one or more second operations may correspond to one or more of outputting one or more warning signals, one or more reset operations, one or more recalibrate operations, one or more shutdown operations, one or more operations associated with adjusting and/or modifying signals being generated and/or processed, one or more operations associated with adjusting and/or modifying signal processing techniques, one or more operations associated with adjusting and/or modifying settings and/or parameters (e.g., one or more of frequency settings, phase settings, amplitude settings, sampling settings, signal conversion settings, etc.) used for processing and/or generating signals by the radar circuit 302, etc.

In some examples, the output signal 316 may be indicative of one or more detected reflections and/or one or more properties associated with the one or more detected reflections. The output signal 316 may be converted into a reflection properties signal. Alternatively and/or additionally, the output signal 316 may be indicative of a list of detected objects. The output signal 316 may be converted into an object list signal. It may be appreciated that by using the neuromorphic circuitry 314 to generate the reflection properties signal and/or the object list signal rather than one or more digital components, less power may be consumed by the sensor and/or less disturbances and/or noise may be introduced to (surrounding) circuits and/or signals, which may result in improved performance of the sensor.

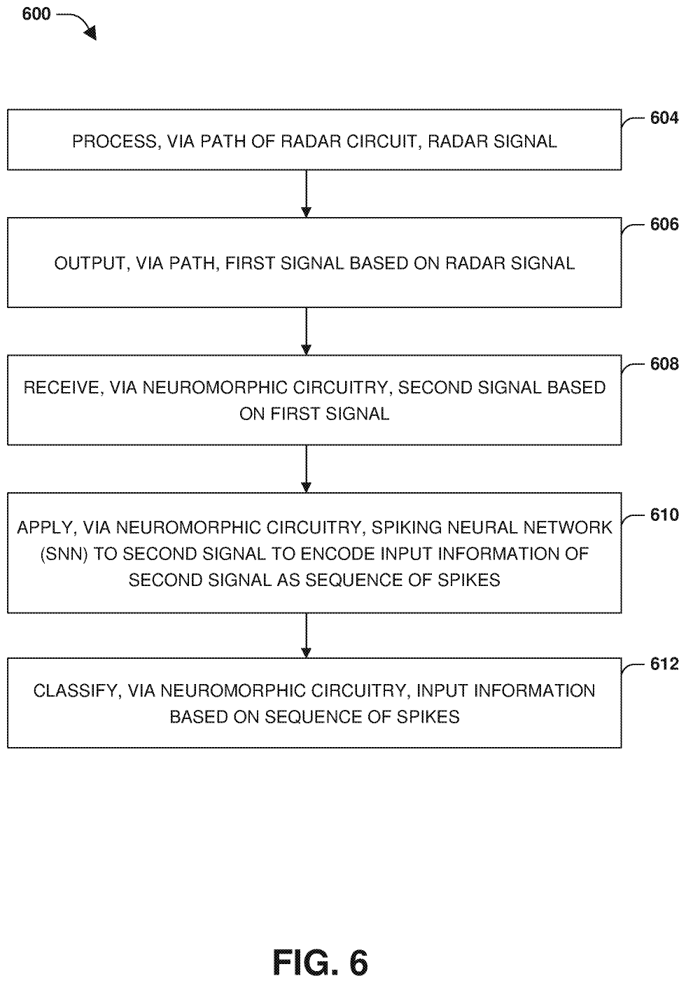

FIG. 6 is an illustration of an exemplary method 600. At 604, a radar signal (e.g., the radar receive signal 308 and/or the radar transmit signal 310 illustrated in FIG. 3) may be received via a path (e.g., the receive path 304 and/or the transmit path 306 illustrated in FIG. 3) of a radar circuit (e.g., the radar circuit 302 illustrated in FIG. 3). For example, the radar signal may be received by a sensor, such as a radar sensor. At 606, a first signal based upon the radar signal may be output via the path. At 608, a second signal (e.g., the second signal 318 and/or the fourth signal 320 illustrated in FIG. 3) based upon the first signal may be received via neuromorphic circuitry (e.g., the neuromorphic circuitry 314 illustrated in FIG. 3). At 610, a SNN (e.g., the SNN 100 illustrated in FIG. 1) may be applied to the second signal via the neuromorphic circuitry to encode input information of the second signal as a sequence of spikes. At 612, the input information may be classified via the neuromorphic circuitry based upon the sequence of spikes.

In some examples, the input information may be classified via the neuromorphic circuitry as being associated with one or more classifications of a plurality of classifications. Alternatively and/or additionally, a transmission signal (e.g., the output signal 316 illustrated in FIG. 3) may be generated based upon the first classification.

In some examples, a first configuration of neurons of the SNN may be applied to the second signal to encode the input information as the sequence of spikes. The first configuration may be updated based upon the sequence of spikes to generate a second configuration of neurons of the SNN.

C. Computing Environment

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

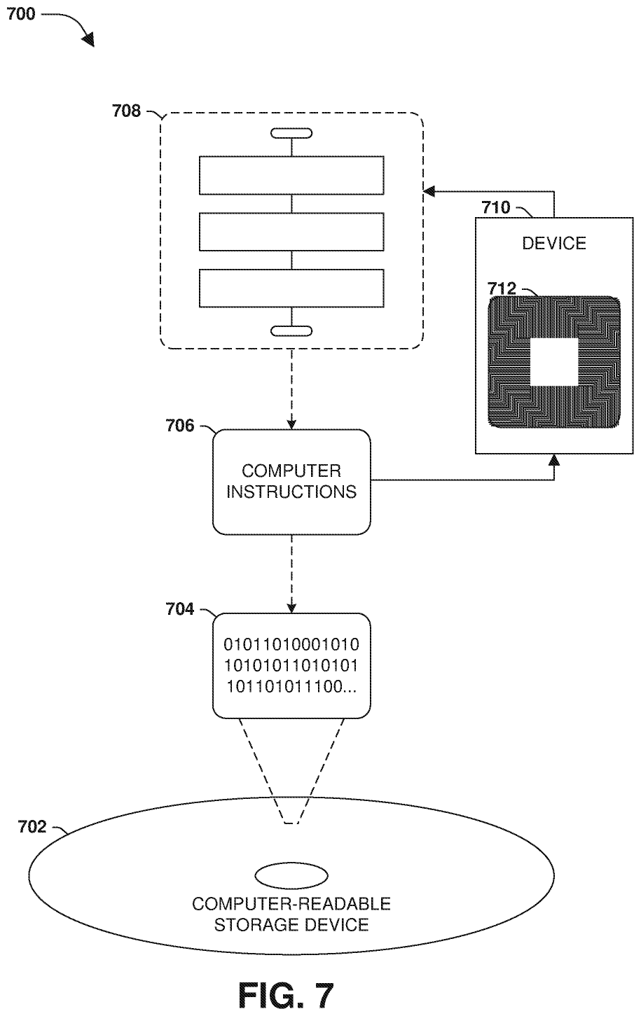

An example computer-readable medium that may be devised in these ways is illustrated in FIG. 7, wherein the implementation 700 comprises a computer-readable memory device 702 (e.g., a CD-R, DVD-R, or a platter of a hard disk drive), on which is encoded computer-readable data 704. This computer-readable data 704 in turn comprises a set of processor-executable computer instructions 706 that, when executed on a processor 712 of a device 710, provide an embodiment that causes the device 710 to operate according to the techniques presented forth herein. Many such computer-readable media may be devised by those of ordinary skill in the art that are configured to operate in accordance with the techniques presented herein. In some embodiments, the processor-executable computer instructions 706 are configured to perform a method 708, such as at least some of the exemplary method 600 of FIG. 6, for example. In some embodiments, the processor-executable computer instructions 706 are configured to implement a system, such as at least some of the exemplary system of FIG. 1, at least some of the exemplary system 200 of FIG. 2, at least some of the exemplary system 300 of FIG. 3, at least some of the exemplary system 400 of FIG. 4 and/or at least some of the exemplary system 500 of FIG. 5, for example. Many such computer-readable media are contemplated to operate in accordance with the techniques presented herein.

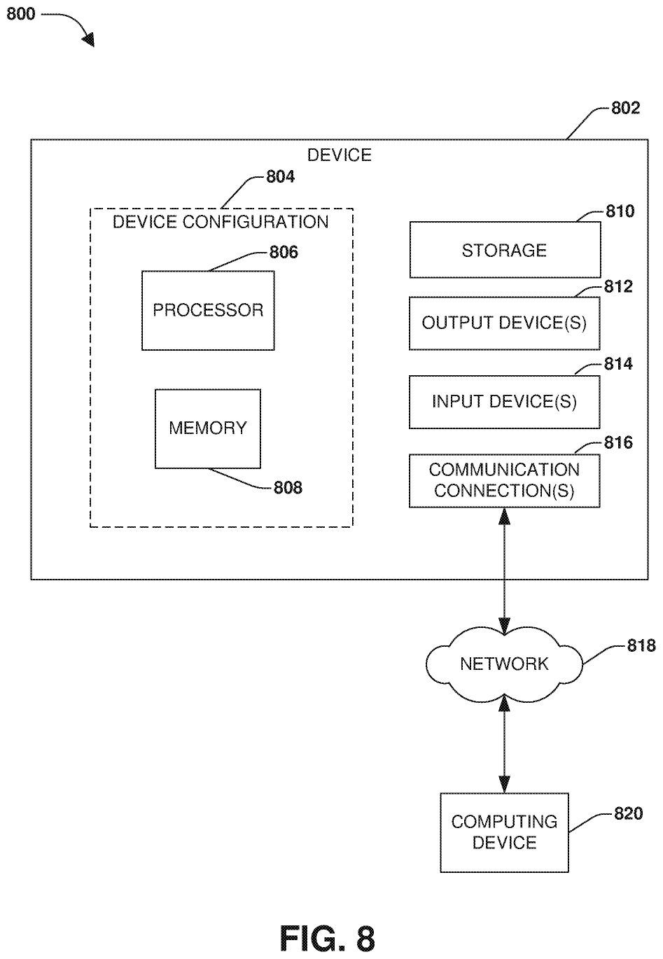

FIG. 8 and the following discussion provide a brief, general description of a suitable computing environment to implement embodiments of one or more of the provisions set forth herein. The operating environment of FIG. 5 is only one example of a suitable operating environment and is not intended to suggest any limitation as to the scope of use or functionality of the operating environment. Example computing devices include, without limitation, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example 800 of a system comprising a computing device 802 configured to implement one or more embodiments provided herein. In one configuration, computing device 802 includes a processing unit 806 and memory 808. Depending on the exact configuration and type of computing device, memory 808 may be volatile (such as RAM, for example), non-volatile (such as ROM, flash memory, etc., for example), or some combination of the two. This configuration is illustrated in FIG. 8 by dashed line 804.

In some embodiments, device 802 may include additional features and/or functionality. For example, device 802 may also include additional storage (e.g., removable and/or non-removable) including, without limitation, magnetic storage, optical storage, and the like. Such additional storage is illustrated in FIG. 8 by storage 810. In one embodiment, computer readable instructions to implement one or more embodiments provided herein may be in storage 810. Storage 810 may also store computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, without limitation, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, without limitation, a modem, a Network Interface Card (NIC), an integrated network interface, an RF transmitter/receiver, an infrared port, a USB connection, or other interfaces for connecting device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of device 802 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In an embodiment, components of device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access the computing device 820 and download a part or all of the computer readable instructions for execution. Alternatively, computing device 802 may download pieces of the computer readable instructions, as needed, or some instructions may be executed at computing device 802 and some at computing device 820.

D. Claim Summary

An embodiment of the presently disclosed techniques comprises a sensor comprising a path configured to process a radar signal and output a first signal based upon the radar signal. The sensor comprises neuromorphic circuitry configured to: receive a second signal based upon the first signal; apply a SNN to the second signal to encode input information of the second signal as a sequence of spikes; and classify the input information based upon the sequence of spikes.

According to some embodiments, the radar circuit and the neuromorphic circuitry are implemented on one semiconductor chip.

According to some embodiments, the path is configured to process radar signals concurrently with the neuromorphic circuitry applying the SNN to the second signal.

According to some embodiments, the neuromorphic circuitry comprises pure analog operating circuitry configured to encode the input information and to classify the input information.

According to some embodiments, the SNN is an analog SNN.

According to some embodiments, the neuromorphic circuitry is configured to: apply a first configuration of neurons of the SNN to the second signal to encode the input information as the sequence of spikes; and update the first configuration of neurons of the SNN based upon the sequence of spikes to generate a second configuration of neurons of the SNN.

According to some embodiments, the neuromorphic circuitry is configured to: receive a third signal; apply the second configuration of neurons of the SNN to the third signal to encode second input information of the third signal as a second sequence of spikes; and update the second configuration of neurons of the SNN based upon the second sequence of spikes to generate a third configuration of neurons of the SNN.

According to some embodiments, the neuromorphic circuitry is configured to classify the input information as being associated with a first classification of a plurality of classifications, wherein the sensor comprises a transmitter configured to generate a transmission signal based upon the first classification.

According to some embodiments, the neuromorphic circuitry is configured to classify the input information as being associated with at least one classification of a plurality of classifications, wherein a first classification of the plurality of classifications corresponds to noise and a second classification of the plurality of classifications corresponds to a reflection from an object.

According to some embodiments, a third classification of the plurality of classifications corresponds to a peak associated with at least one of a first distance of an object or a first velocity of the object.

According to some embodiments, a fourth classification of the plurality of classifications corresponds to a correct operation of the path and a fifth classification of the plurality of classifications corresponds to an incorrect operation of the path.

According to some embodiments, the path comprises a receive path and/or a transmit path.

An embodiment of the presently disclosed techniques comprises a method. The method comprises: processing, via a path of a radar circuit, a radar signal; outputting, via the path, a first signal based upon the radar signal; receiving, via neuromorphic circuitry, a second signal based upon the first signal; applying, via the neuromorphic circuitry, a SNN to the second signal to encode input information of the second signal as a sequence of spikes; and classifying, via the neuromorphic circuitry, the input information based upon the sequence of spikes.

According to some embodiments, classifying the input information comprises classifying, via the neuromorphic circuitry, the input information as being associated with a first classification of a plurality of classifications; and the method comprises generating a transmission signal based upon the first classification.

According to some embodiments, the method comprises: applying, via the neuromorphic circuitry, a first configuration of neurons of the SNN to the second signal to encode the input information as the sequence of spikes; and updating, via the neuromorphic circuitry, the first configuration of neurons of the SNN based upon the sequence of spikes to generate a second configuration of neurons of the SNN.

An embodiment of the presently disclosed techniques comprises an apparatus. The apparatus comprises a means for processing, via a path of a radar circuit, a radar signal. The apparatus comprises a means for outputting, via the path, a first signal based upon the radar signal. The apparatus comprises a means for receiving, via neuromorphic circuitry, a second signal based upon the first signal. The apparatus comprises a means for applying, via the neuromorphic circuitry, a SNN to the second signal to encode input information of the second signal as a sequence of spikes. The apparatus comprises a means for classifying, via the neuromorphic circuitry, the input information based upon the sequence of spikes.

An embodiment of the presently disclosed techniques comprises a non-transitory machine readable medium comprising instructions for performing a method, which when executed by a machine, causes the machine to: process, via a path of a radar circuit, a radar signal; output, via the path, a first signal based upon the radar signal; receive, via neuromorphic circuitry, a second signal based upon the first signal; apply, via the neuromorphic circuitry, a SNN to the second signal to encode input information of the second signal as a sequence of spikes; and classify, via the neuromorphic circuitry, the input information based upon the sequence of spikes.

An embodiment of the presently disclosed techniques comprises a device configured to: process, via a path of a radar circuit, a radar signal; output, via the path, a first signal based upon the radar signal; receive, via neuromorphic circuitry, a second signal based upon the first signal; apply, via the neuromorphic circuitry, a SNN to the second signal to encode input information of the second signal as a sequence of spikes; and classify, via the neuromorphic circuitry, the input information based upon the sequence of spikes.

According to some embodiments, the device is implemented as a finite state machine.

According to some embodiments, the device is implemented as at least one of a hardware device or a software device.

An embodiment of the presently disclosed techniques comprises a semiconductor device comprising a circuit configured to generate information. The semiconductor device comprises a monitoring circuit, coupled to the circuit, configured to receive a monitoring signal from the circuit based upon the information. The monitoring circuit comprises a SNN configured to determine, based upon the monitoring signal, a first monitoring classification of a plurality of monitoring classifications associated with the circuit.

According to some embodiments, the circuit is configured to generate the information concurrently with operation of the SNN to determine monitoring information based upon the monitoring signal.

According to some embodiments, the SNN is configured to receive a signal indicative of an operation performed as a result of applying a control signal to the circuit to generate the information.

According to some embodiments, the first monitoring classification corresponds to a correct execution of operations.

According to some embodiments, the correct execution of operations corresponds to at least one of a correct timing of the operations or a correct order of the operations.

According to some embodiments, the monitoring signal is a tapped signal tapped at at least one circuit node of the circuit, wherein the tapped signal is applied to at least one neuron of the SNN.

E. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. One or more components may be localized on one computer and/or distributed between two or more computers.

Furthermore, embodiments may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of embodiments.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A sensor comprising:
a radar circuit, the radar circuit comprising a path configured to process a radar signal and output a first signal based upon the radar signal; and
neuromorphic circuitry configured to:
receive a second signal based upon the first signal;
apply a spiking neural network (SNN) to the second signal to encode input information of the second signal as a sequence of spikes; and
classify the input information based upon the sequence of spikes.

2. The sensor of claim 1, wherein the radar circuit and the neuromorphic circuitry are implemented on one semiconductor chip.

3. The sensor of claim 1, wherein the path is configured to process radar signals concurrently with the neuromorphic circuitry applying the SNN to the second signal.

4. The sensor of claim 1, wherein:
the neuromorphic circuitry comprises pure analog operating circuitry configured to encode the input information and to classify the input information; and
the SNN is an analog SNN.

5. The sensor of claim 1, wherein the neuromorphic circuitry is configured to:
apply a first configuration of neurons of the SNN to the second signal to encode the input information as the sequence of spikes; and
update the first configuration of neurons of the SNN based upon the sequence of spikes to generate a second configuration of neurons of the SNN.

6. The sensor of claim 5, wherein the neuromorphic circuitry is configured to:
receive a third signal;
apply the second configuration of neurons of the SNN to the third signal to encode second input information of the third signal as a second sequence of spikes; and
update the second configuration of neurons of the SNN based upon the second sequence of spikes to generate a third configuration of neurons of the SNN.

7. The sensor of claim 1, wherein the neuromorphic circuitry is configured to classify the input information as being associated with a first classification of a plurality of classifications, the sensor comprising:
a transmitter configured to generate a transmission signal based upon the first classification.

8. The sensor of claim 1, wherein the neuromorphic circuitry is configured to classify the input information as being associated with at least one classification of a plurality of classifications, wherein a first classification of the plurality of classifications corresponds to noise and a second classification of the plurality of classifications corresponds to a reflection from an object.

9. The sensor of claim 1, wherein the neuromorphic circuitry is configured to classify the input information as being associated with at least one classification of a plurality of classifications, wherein a first classification of the plurality of classifications corresponds to a peak associated with at least one of a first distance of an object or a first velocity of the object.

10. The sensor of claim 1, wherein the neuromorphic circuitry is configured to classify the input information as being associated with at least one classification of a plurality of classifications, wherein a first classification of the plurality of classifications corresponds to a correct operation of the path and a second classification of the plurality of classifications corresponds to an incorrect operation of the path.

11. The sensor of claim 1, wherein the path comprises at least one of a receive path or a transmit path.

12. A method comprising:
processing, via a path of a radar circuit, a radar signal;
outputting, via the path, a first signal based upon the radar signal;
receiving, via neuromorphic circuitry, a second signal based upon the first signal;
applying, via the neuromorphic circuitry, a spiking neural network (SNN) to the second signal to encode input information of the second signal as a sequence of spikes; and
classifying, via the neuromorphic circuitry, the input information based upon the sequence of spikes.

13. The method of claim 12, wherein:
classifying the input information comprises classifying, via the neuromorphic circuitry, the input information as being associated with a first classification of a plurality of classifications; and
the method comprises generating a transmission signal based upon the first classification.

14. The method of claim 12, comprising:
applying, via the neuromorphic circuitry, a first configuration of neurons of the SNN to the second signal to encode the input information as the sequence of spikes; and
updating, via the neuromorphic circuitry, the first configuration of neurons of the SNN based upon the sequence of spikes to generate a second configuration of neurons of the SNN.

15. A semiconductor device comprising:
a circuit configured to generate information; and
a monitoring circuit, coupled to the circuit, configured to receive a monitoring signal from the circuit based upon the information, the monitoring circuit comprising a spiking neural network (SNN) configured to determine, based upon the monitoring signal, a first monitoring classification of a plurality of monitoring classifications associated with the circuit.

16. The semiconductor device of claim 15, wherein the circuit is configured to generate the information concurrently with operation of the SNN to determine monitoring information based upon the monitoring signal.

17. The semiconductor device of claim 15, wherein the SNN is configured to receive a signal indicative of an operation performed as a result of applying a control signal to the circuit to generate the information.

18. The semiconductor device of claim 15, wherein the first monitoring classification corresponds to a correct execution of operations.

19. The semiconductor device of claim 18, wherein the correct execution of operations corresponds to at least one of a correct timing of the operations or a correct order of the operations.

20. The semiconductor device of claim 15, wherein the monitoring signal is a tapped signal tapped at at least one circuit node of the circuit, wherein the tapped signal is applied to at least one neuron of the SNN.
